(19) United States
(12) Patent Application Publication
(10) Pub. No.: US 2013/0042664 A1
(43) Pub. Date: Feb. 21, 2013

(54) Method for the functional checking of an inertial sensor and inertial sensor

(71) Applicants: Martin Wrede, Reutlingen (DE); Klaus Petzold, Reutlingen (DE); Burkhard Kuhlmann, Reutlingen (DE); Uwe Tellermann, Reutlingen (DE); Markus Brockmann, Tuebingen (DE); Marian Keck, Leonberg (DE); Thorsten Balslink, Kirchentellinsfurt (DE)

(72) Inventors: Martin Wrede, Reutlingen (DE); Klaus Petzold, Reutlingen (DE); Burkhard Kuhlmann, Reutlingen (DE); Uwe Tellermann, Reutlingen (DE); Markus Brockmann, Tuebingen (DE); Marian Keck, Leonberg (DE); Thorsten Balslink, Kirchentellinsfurt (DE)

(21) Appl. No.: 13/586,282

(22) Filed: Aug. 15, 2012

(30) Foreign Application Priority Data
Aug. 16, 2011 (DE) 10 2011 081 026.9

(51) Int. Cl. G01P 15/097; G01P 21/00

(52) U.S. Cl. 73/1.38; 73/654

(57) ABSTRACT

A method for providing functional checking of an inertial sensor, a first test signal having a first frequency being fed in at a test electrode of the inertial sensor for exciting a vibration of a vibration mass and a first response signal corresponding to the vibration mass is recorded, a second test signal having a second frequency different from the first frequency being fed in at the test electrode, a second response signal corresponding to the vibration mass being recorded, and the two response signals being evaluated. Also described is an inertial sensor.

### RELATED APPLICATION INFORMATION

The present application claims priority to and the benefit of German patent application no. 10 2011 081 026.9, which was filed in Germany on Aug. 16, 2011, the disclosure of which is incorporated herein by reference.

### FIELD OF THE INVENTION

The exemplary embodiments and/or exemplary methods of the present invention relate to the functional checking of an inertial sensor and an inertial sensor.

### BACKGROUND INFORMATION

German Laid-Open document DE 10 2009 003 217 A1, for example, discusses a method for the functional checking of a yaw-rate sensor. In this instance, a test signal is fed into a quadrature feedback control system and a corresponding response signal is recorded. A change in the recorded response signal from an expected response signal is particularly a measure for a sensitivity error of the yaw-rate sensor.

### SUMMARY OF THE INVENTION

An object on which the exemplary embodiments and/or exemplary methods of the present invention is based may be seen in stating a method for the functional checking of an inertial sensor which, even in response to external interference variables, enables a reliable functional checking.

The object on which the exemplary embodiments and/or exemplary methods of the present invention is based may also be seen in stating a corresponding inertial sensor.

These objects may be attained using the respective subject matter described herein. Advantageous embodiments are the subject of the further descriptions herein.

According to one aspect, a method is provided for the functional checking of an inertial sensor, a first test signal having a first frequency being fed in at a test electrode of the inertial sensor for exciting a vibration of a vibrating mass and records a first response signal corresponding to the vibration mass, a second test signal having a second frequency different from the first frequency being fed in at the test electrode, a second response signal corresponding to the vibration mass being recorded, and the two response signals are evaluated, in particular, are compared to each other.

According to one further aspect, an inertial sensor is provided including a vibration mass, a feed-in electrode for exciting a vibration of the vibration mass for feeding a first test signal using a first frequency and a second test signal having a second frequency that is different from the first frequency, a recording device for recording a corresponding first and second response signal, respectively, of the vibration mass and an evaluation device for evaluating, particularly comparing the response signals.

Because two test signals having different frequencies are fed in at the feed-in electrode, advantageously also two corresponding response signals of the oscillating mass are formed. In the case of outer accelerations or outer vibrations, it may happen, to be sure, that therefore one of the signals is interfered with. Since, however, the outer acceleration or vibration, based on the different frequencies of the test signals, as a rule, are not also able simultaneously to interfere with the other test signal to the same degree, one is advantageously able to achieve a reliable functional checking. This means especially that the probability of interference is advantageously considerably reduced.

In particular, when the outer acceleration or the outer vibration has a frequency which is the same as one of the two frequencies in so far as a differential frequency is less than a frequency of a filter of the two test signals, a signal is able to be created which is hardly or no longer able to be distinguished from the respective test signal. However, since for the functional checking always still an additional test signal having a different frequency is available, which causes a corresponding differential frequency to become greater than a frequency of the filter, an additional signal is created which does not influence or interfere with the second response signal. Thus, advantageously an inertial sensor is created which, even in the case of outer vibrations or accelerations makes functional checking reliably possible, so that especially sensitivity errors are able to be detected in a reliable manner. This being the case, the inertial sensor is particularly robust to vibrations.

Since the feed-in electrode is particularly used to feed in the test signals, it may also be designated as a test electrode. A test electrode or feed-in electrode within the meaning of the present invention is particularly developed to deflect the vibration mass, for instance, using an electrical field and/or a magnetic field. A test signal which is fed in to the test electrode thus leads particularly to a corresponding deflection of the vibration mass. This deflection is recorded as a response signal. Since the test signal is known, a theoretical response signal may be calculated, the theoretical response signal being particularly compared to the recorded response signal. A deviation is able to point towards a fault function of the inertial sensor. That being the case, a response signal corresponding to the vibration mass, within the meaning of the present invention, particularly means a response signal proportional to the deflection, vibration or motion of the vibration mass.

In particular, when both response signals are simultaneously detected as being faulty, that is, particularly that the recorded response signals do not correspond to the expected response signals, one may reason from this, for example, that a sensitivity error of the inertial sensor lies outside the original error tolerance or another faulty function has occurred. In particular, when both response signals are several times simultaneously wrong, one after the other in time, such a deviation is present or another faulty function. The expected response signal may be calculated theoretically, for example.

The exciting of the vibration of the vibration mass may particularly also include a control or regulation of the vibration of the vibration mass. That being the case, the method may particularly also be designated as a method for controlling or regulating a vibration of a vibration mass.

According to one specific embodiment, it may be provided that the first test signal is fed into a feedback control circuit for regulating the vibration of the vibration mass of the inertial sensor and the corresponding first response signal is recorded. Furthermore, particularly the second test signal is fed into the feedback control circuit and the corresponding second response signal is recorded, the two response signals being evaluated, particularly compared to each other.

According to one specific embodiment, the second frequency is indivisible by the first frequency. This means especially that the second frequency is not a multiple of the first frequency. The feed-in electrode is thus particularly further developed to feed in the second test signal having a second frequency which is not divisible by a first frequency of the first test signal. It is thereby advantageously avoided that interference frequencies, that is, frequencies of an outer interference, such as vibrations or accelerations, are able to be superposed over both frequencies of the test signals to the same degree. According to an additional specific embodiment, the test signals may have a rectangular shape and/or be particularly developed as a DC (direct current) signal and/or be developed, for example, as a DC voltage signal.

According to another specific embodiment, a voltage that is constant during the functional checking is applied to the feed-in electrode, in order to add a respective voltage level of the two test signals to the applied voltage. To do this, a voltage source may be connected to the feed-in electrode or the test electrode for applying a voltage that is constant during a functional checking, for instance, using a switch, particularly using a Q-electrode-switch. Thus a functional separation is undertaken of the feed-in electrode from additional possible electrodes, if the feed-in electrode takes over no additional functions during a functional checking, particularly no regulating functions. This functional separation lowers advantageously a compensation effort which would be created if an electrode simultaneously had to satisfy the function of a feed-in electrode and a regulating electrode. Thus, this means in particular that the feed-in electrode need not be included by the feedback control circuit, that is, is formed separately from it.

In the related art it was necessary for each working point of the feed-in electrode periodically to add another voltage having the frequency of the test signal, which requires, for example, a so-called look-up table, as in German Laid-Open document DE 10 2009 003 217 A1, which has to be calculated individually for each inertial sensor and written into a nonvolatile memory. Such a look-up table may thus advantageously be dispensed with, which saves, for instance, material and costs.

According to still another specific embodiment, the feedback control circuit includes a regulator for a regulator electrode for regulating the deflection of the vibration mass, a filtering of the fed-in test signals that is preconnected to the regulator being carried out. For this, a filter for filtering the test signal, which is fed into the feedback control circuit, may be preconnected to the controller, especially an integral-action controller, for the controller electrode. Consequently, the filter advantageously prevents test signals from being able to influence the controller electrode in such a way that the latter deflects the vibration mass so that the test signals are regulated to zero, which would then prevent the corresponding response signals from developing. Since it may be provided that the test signals are not fed into the feedback control circuit, in this case the filter for filtering the vibration mass signal is provided in order to filter out the response signals to the fed-in test signals from the feedback control circuit. Because of that, the influencing of the test signals by the feedback control circuit or the influencing of the feedback control circuit by the test signals is advantageously avoided. The filter may be developed as a comb filter which, in particular, has zero values in the case of the first and/or the second frequency of the test signals. Thereby, an ideal suppression of the test signals is advantageously effected, without convolution of other spectral portions into a baseband.

In one other specific embodiment, before comparing the two response signals, a low pass filtering of the first and the second response signal is carried out. For this, a low pass filter may be preconnected to the evaluation device for the low pass filtering of the two response signals. This advantageously has the effect that the test signals are prone to interference in only a very narrow band frequency range, so that thereby the sensitivity with respect to the functional checking is able to be increased further. In addition, advantageously the robustness with respect to interference signals is increased further thereby.

According to a still further specific embodiment, two separately formed recording paths may be provided for the two response signals. This means especially that one demodulation is carried out separately for the two response signals. Thus, this means in particular that a first recording path is formed, on which the demodulation for the first response signal is carried out, and in addition a second recording path is formed on which the demodulation for the second response signal is carried out. In both recording paths a low pass filter may be connected, which carries out the low pass filtering of the first and the second response signal, respectively. The low pass filters may be formed to be equal or different.

In one additional specific embodiment, the functional test, which may generally be designated also as self test, is carried out continuously and/or in the running operation of the inertial sensor, so that advantageously errors are able to be detected and signaled directly in running operation.

In yet another specific embodiment, the feedback control circuit is configured as a quadrature feedback control system. Such a quadrature feedback control system in particular compensates advantageously for a quadrature portion that is created as follows:

The inertial sensor, in this instance, in this specific embodiment includes especially one additional vibration mass, whereupon in the following, the vibration mass may be designated as a detection mass and the additional vibration mass as a driving mass. One or more detection electrodes may be provided which are assigned to the detection mass and, for instance, are able to record a deflection of the detection mass capacitively. The driving mass may particularly be excited to vibration using driving electrodes. The test signals may be formed using excitation of the detection mass. The detection electrode or the detection electrodes may be configured as feed-in electrodes. This means, in particular, that these electrodes are able to effect both functionalities, detection and feeding in.

In this instance, a particular vibrational direction x of the driving mass may be orthogonal to a particular vibrational direction y of the detection mass. By a mechanical connection, especially using a spring device in a particular vibrational direction y of the detection mass a Coriolis force F_{C} acting on the driving mass is transmitted to the detection mass, which is created based on a yaw rate Ω of the inertial sensor. Since generally no exact orthogonality of the two vibration directions x and y is present, as a result of the deflection of the driving mass, a second force component F_{Q}, that is different from the Coriolis force F_{C}, is created, which is designated as the quadrature portion, in the particular vibrational direction y of the detection mass.

The Coriolis portion and the quadrature portion are phase-shifted by 90° from each other, so that the two components F_{C} and F_{Q} are able to be ascertained and recorded separated and separately, particularly using a demodulation having a frequency ω_{A} of a driving vibration of the driving mass. A corresponding demodulator then generates a quadrature signal. The demodulation of a detection signal of the detection mass, which is offset using a phase shifter by 90°, supplies a measuring signal which is proportional to the yaw rate Ω. The recording of the detection signal may particularly take place using an open loop or closed loop configuration. An output signal of the controller, particularly of the integral-action controller, counteracts the cause of quadrature F_{Q}, in that, in particular, an output signal converted to voltage, is able to be supplied to the controller electrode which, in this instance, may also be designated as a quadrature compensation electrode. The controller may also be designated particularly as a quadrature controller, in this instance. Using a correspondingly developed form of electrode, a transverse force may be generated, which is x-proportional to the deflection, and in particular, advantageously, a direction of the driving vibration is rotated so far until its force effect F_{Q} on the detection vibration vanishes. The quadrature compensation electrode may be used for feeding in the two test signals. In particular, however, a feeding electrode may be used which is formed separated from the quadrature compensation electrode.

According to one specific embodiment, the inertial sensor is formed as a micromechanical sensor. The inertial sensor may be a yaw-rate sensor or an acceleration sensor, for example. The inertial sensor may be used in the automobile sector, especially in vehicles. The self test is carried out particularly when switching on or starting the vehicle. The self test may be carried out continuously. This means, in particular, that during the operation of the inertial sensor, that is, the self test is carried out especially when the inertial sensor records inertial forces acting upon it, that is, particularly at the same time as the recording of the inertial forces.

According to another specific embodiment, in the specific embodiments named above, one may do without the feeding of the second test signal. This means particularly that only one test signal is fed in. This being the case, the feeding-in electrode feeds in only one test signal, the recording device records only one response signal and the evaluation device evaluates only one response signal. It turned out surprisingly that especially the specific embodiments having the functional separation between a feeding-in electrode and additional electrodes, especially a controller electrode, and the specific embodiments having the preconnected filter connected before the controller, each taken by itself or even in combination, but without the feeding in of two test signals having different frequencies, sufficiently have the effect that a reliable and vibration-robust functional checking is able to be carried out, so that particularly sensitivity errors are able to be detected particularly simply and reliably.

The exemplary embodiments and/or exemplary methods of the present invention are explained in greater detail below on the basis of exemplary embodiments with reference to the figures. The same reference numerals are used below for the same features.

### BRIEF DESCRIPTION OF THE DRAWINGS

FIG. 1 shows a flow chart of a method for the functional checking of an inertial sensor.

FIG. 2 shows an inertial sensor.

FIG. 3 shows an additional inertial sensor.

### DETAILED DESCRIPTION

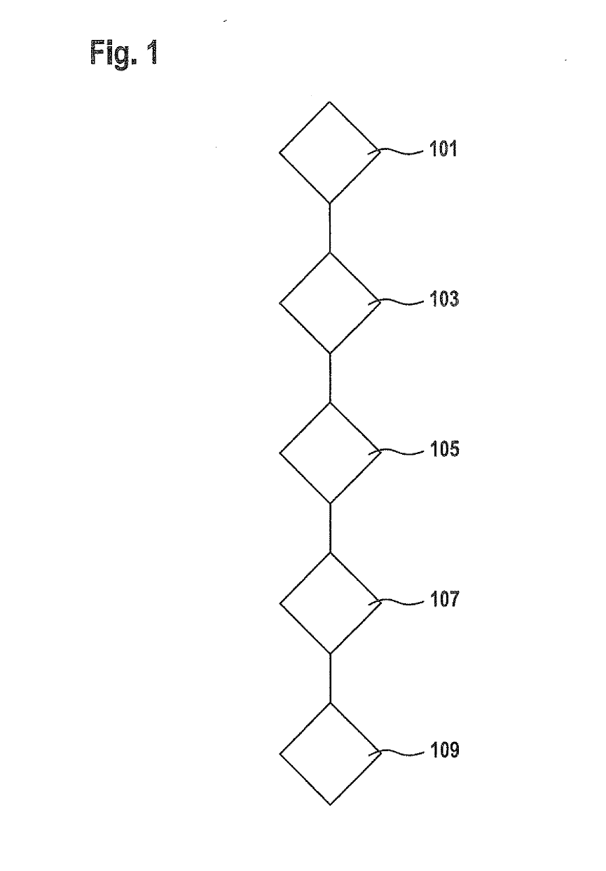

FIG. 1 shows a flow chart of a method for the functional checking of an inertial sensor. In a step 101, a first test signal having a first frequency is fed in at a feed-in electrode to excite a vibration of a vibration mass of the inertial sensor. In a step 103, a corresponding first response signal of the vibration mass is then recorded. According to a step 105, a second test signal 105 having a second frequency that is different from the first frequency is fed in at the feed-in electrode, in a step 107, a corresponding second response signal of the vibration mass being recorded. In a step 109, the two response signals are evaluated. The two test signals may be fed in simultaneously or one after the other in time.

A malfunction of the inertial sensor, for example, is established when both response signals are faulty at the same time. A malfunction of the inertial sensor may be established when both response signals are faulty several times, one after the other.

The providing of two test signals having different frequencies particularly has the advantage that outer accelerations or vibrations are not able to interfere with both test signals simultaneously to the same degree, based on the different frequencies, which being the case, enables a particularly reliable functional testing of the inertial sensor.

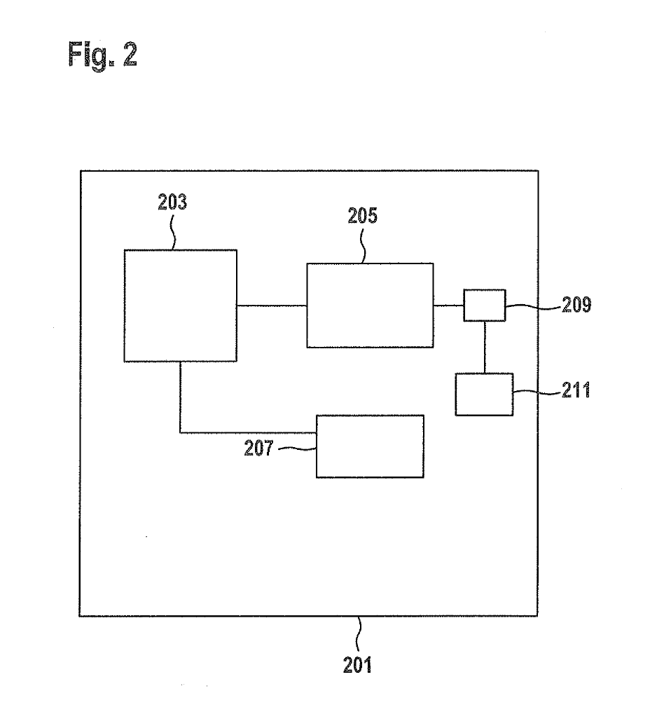

FIG. 2 shows an inertial sensor 201, including a vibration mass 203. Furthermore, a feedback control circuit 205 is provided for regulating the vibration of vibration mass 203. Inertial sensor 201 also has a feed-in electrode 207, which is able to excite vibration mass 203 to vibrate. To do this, a first test signal having a first frequency and a second test signal having a second frequency are fed into feed-in electrode 207. In this instance, the second frequency is different from the first frequency.

Furthermore, inertial sensor 201 includes a recording device 209, which is able to record a corresponding first and second response signal, respectively, of vibration mass 203. Moreover, an evaluation device 211 is provided for evaluating the two response signals. Evaluating device 211 is particularly equipped to compare the response signals to each other.

In one specific embodiment that is not shown, only one feed-in electrode 207 or test electrode is provided for feeding in the two test signals. In this instance, particularly, feedback control circuit 205 is omitted. Test electrode 207 may be developed so that it is able to deflect the vibration mass.

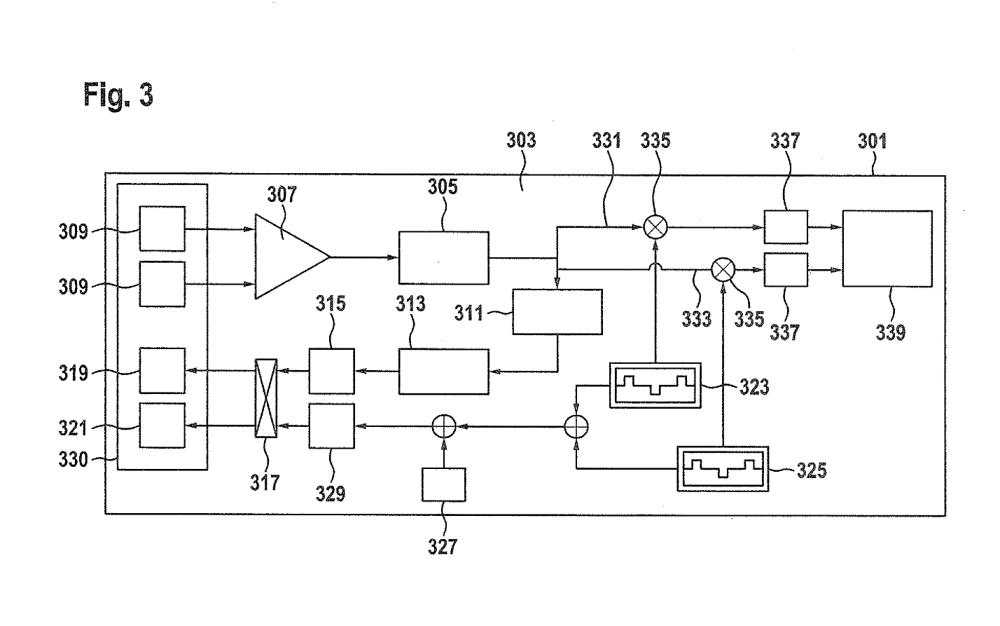

FIG. 3 shows another inertial sensor (301). Inertial sensor 301 includes a quadrature feedback control system 303. Quadrature feedback control system 303 includes particularly a quadrature demodulator 305 for demodulating or separating a measuring signal from an interference signal, in this case especially a quadrature signal. These two signals, which are particularly phase-shifted, particularly by 90°, with respect to each other, are provided using a converter 307, which is particularly equipped to convert a physical variable to an electric measuring variable, a voltage, in this case, that is, a voltage signal. The physical variable may be an acceleration and/or a yaw rate. In this instance, converter 307 receives appropriate input signals from two detection electrodes 309.

Detection electrodes 309 detect capacitively, particularly resistively and/or piezoelectrically, a deflection or vibration of a detection mass that is not shown. This detection mass that is not shown is connected mechanically to a drive mass that is also not shown, a respective particular vibration direction of the two masses being formed to be orthogonal to each other.

The quadrature signal from quadrature demodulator 305 then passes a filter 311, which is preconnected to a digital controller 313. Digital controller 313 is developed particularly as a quadrature controller, especially as an integral-action controller. Filter 311 filters, or rather suppresses the response signals, of the drive mass and the detection mass, that are formed based on test signals that are fed in, so that these signals are not able to get to digital controller 313. A corresponding output signal of digital controller 313 is converted using a digital/analog converter 315 into an analog signal, and made available via a Q-electrode-switch 317 to one of two electrodes 319 and 321. In particular, Q-electrode-switch 317 provides the analog output signal of digital/analog converter 315 to electrode 319, so that the latter takes on the function of a controller electrode. Electrode 319 may thus be designated as a controller electrode.

This being the case, the other electrode 321 then takes on the function of a feed-in electrode for feeding in a first test signal 323 and a second test signal 325 having different frequencies. A respective voltage level of the two test signals 323 and 325 is added to a constant voltage that is provided using a voltage source 327. The signal thus added up is then provided to feed-in electrode 321 via an additional digital/analog converter 329 and Q-electrode-switch 317.

Feed-in electrode 321, controller electrode 319 and the two detection electrodes 309 are included here particularly in a sensor element 330.

Furthermore, a first recording path 331 and a second recording path 333 for recording the corresponding response signals of the quadrature feedback control system 303 are formed. In this case, the two recording paths 331 and 333 are connected to the output of quadrature demodulator 305, so that it provides its demodulated output signal, including the corresponding response signals, to the two recording paths 331 and 333. In the two recording paths 331 and 333 there is situated respectively a modulator 335 which, from the signal provided using quadrature demodulator 305, demodulates the first response signal and the second response signal.

The respective response signal is then in each case provided to a low pass filter 337, such a low pass filter being situated per recording path 331 and 333. The response signals thus filtered are then provided to an evaluation device 339.

In particular, it may be provided that one should optimize the feed-in results for the two test signals 323 and 325 in such a way that the ripples, which could be relevant to the evaluation, are reduced by a minimum.

In the specific embodiment shown in FIG. 3, quadrature feedback control system 303 thus includes particularly quadrature demodulator 305, converter 307, detection electrodes 309, filter 311, digital controller 313, digital/analog converter 315, Q-electrode-switch 317 and controller electrode 319.

In one specific embodiment not shown, inertial sensor 301 may also include only one single recording path, in which case also only one test signal being fed into quadrature feedback control system 303.

In one additional specific embodiment not shown, it may be provided that quadrature feedback control system 303 may be omitted, nevertheless, in spite of this, detection electrodes 309 continuing to be provided. This being the case, in this specific embodiment, particularly only feed-in electrode 321 or the test electrode being provided, at which the two test signals or even only one test signal are/is fed in. The test electrode or feed-in electrode 321 is generally developed particularly for deflecting the vibration mass.

What is claimed is:

1. A method for providing functional checking of an inertial sensor, the method comprising:
feeding a first test signal having a first frequency in at a feed-in electrode of the inertial sensor to excite a vibration of a vibration mass;
recording a first response signal corresponding to the vibration mass;
feeding a second test signal, having a second frequency that is different from the first frequency, in at the feed-in electrode;
recording a second response signal corresponding to the vibration mass; and
evaluating the first response signal and the second response signal.

2. The method of claim 1, wherein the first test signal is fed into a feedback control circuit for regulating the vibration of the vibration mass of the inertial sensor and the first response signal is recorded, wherein the second test signal is fed into the feedback control circuit and the second response signal is recorded, and wherein the two response signals are evaluated.

3. The method of claim 1, wherein the second frequency is indivisible by the first frequency.

4. The method of claim 1, wherein a voltage is applied to the feed-in electrode that is constant during the functional checking, to add a respective voltage level of the first test signal and the second test signal to the applied voltage.

5. The method of claim 2, wherein the feedback control circuit includes a controller for a controller electrode for regulating the vibration of the vibration mass, and wherein a filtering, preconnected to the controller, of the fed-in test signals is performed.

6. The method of claim 1, wherein before the evaluation of the first response signal and the second response signals, a low pass filtering of the first response signal and the second response signal is performed.

7. An inertial sensor, comprising:
a vibration mass;
a feed-in electrode for exciting a vibration of the vibration mass for feeding in a first test signal having a first frequency and a second test signal having a second frequency that is different from the first frequency;
a recording device for recording a first response signal and a second response signal, respectively, corresponding to the vibration mass; and
an evaluation device for evaluating the first response signal and the second response signal.

8. The inertial sensor of claim 7, further comprising:
a feedback control circuit for regulating the vibration of the vibration mass.

9. The inertial sensor of claim 7, wherein the feed-in electrode is configured to feed in the second test signal having a second frequency, which is not divisible by a first frequency of the first test signal.

10. The inertial sensor of claim 7, wherein a voltage source is connected to the feed-in electrode for applying a voltage that is constant during a functional checking of the inertial sensor.

11. The inertial sensor of claim 8, wherein the feedback control circuit includes a controller for a controller electrode for regulating the vibration of the vibration mass and a filter for filtering the first test signal and the second test signal fed into the feedback control circuit being preconnected to the controller.

12. The inertial sensor of claim 7, wherein a low pass filter for a low pass filtering of the first response signal and the second response signal is preconnected to the evaluation device.
